(19) United States
(12) Patent Application Publication
(10) Pub. No.: US 2015/0347855 A1
(43) Pub. Date: Dec. 3, 2015

(54) Clothing Stripe Detection Based on Line Segment Orientation

(71) Applicant: HEWLETT-PACKARD DEVELOPMENT COMPANY, L.P., Houston, TX (US)

(72) Inventors: XIANWANG WANG, SUNNYVALE, CA (US); TONG ZHANG, PALO ALTO, CA (US); DANIEL R TRETTER, PALO ALTO, CA (US)

(21) Appl. No.: 14/437,385

(22) PCT Filed: Sep. 27, 2012
(86) PCT No.: PCT/US2012/057459

§ 371 Date: Apr. 21, 2015

(51) Int. Cl. G06K 9/00; G06K 9/46; G06K 9/66

(52) U.S. Cl. CPC G06K 9/00771; G06K 9/66; G06K 9/4652; G06K 9/4604

(57) ABSTRACT

Examples disclosed herein relate to clothing stripe detection based on line segment orientation. A processor may determine whether a clothing region within an image includes stripes based on a stripe classifier applied to line segment information about line segments in the clothing region. The line segment information may include the number of line segments in the clothing region at each of a plurality of orientations. The processor may output information indicating the determination of whether the clothing region includes stripes

### BACKGROUND

Image analysis may provide information about the contents of an image. In some cases, clothing within an image may be analyzed to determine information about people in the image. For example, clothing analysis may be used to identify a person for organizing photographs or for identifying a person as part of surveillance,

### BRIEF DESCRIPTION OF THE DRAWINGS

The drawings describe example embodiments. The following detailed description references the drawings, wherein:

FIG. 1 is a block diagram illustrating one example of a computing system to detect clothing stripes in an image.

FIG. 2 is a flow chart illustrating one example of a method to detect clothing stripes in an image.

FIG. 3 is a diagram illustrating one example of detecting clothing stripes in an image.

FIG. 4 is a flow chart illustrating one example of detecting clothing stripes in an image.

### DETAILED DESCRIPTION

Detecting the presence of stripes in clothing in an image may be useful for identifying a type of clothing within an image. The clothing information may be used for image organization or search. In some cases, the presence of stripes in clothing may be used to identify a person, such as surveillance video searching for a person wearing stripes. An image analysis method may identify a person based on facial and clothing characteristics, including whether the person is wearing stripes.

In one implementation, image analysis may be performed to determine whether clothing stripes are present within an image based on the orientation of line segments within the image. For example, line segments in the image that are determined to be stripe candidates may be clustered based on their orientation, and a machine learning classifier may determine the likelihood that a cluster of line segments are stripes based on the orientation of the stripe candidate line segments compared to line segment orientation rules learned from a training data set. In some cases, the method may be used both to detect the presence of stripes and to determine the dominant orientation of the stripes, such as horizontal or vertical.

Using the orientation of line segments within an image to detect stripes may be particularly applicable to clothing. Clothing stripes may include several line segments of the same orientation, but in some cases, not all of the line segment indicating stripes will be in the same orientation, such as due to the position of the person or wrinkles in the clothing. Clothing stripes may appear different than stripes on other items because of natural folds for sleeves and other areas, or due to different visible portions of the clothing in an image. A machine learning classifier for determining line segment cluster orientations indicative of clothing stripes may account for the differing orientations of clothing stripes in images.

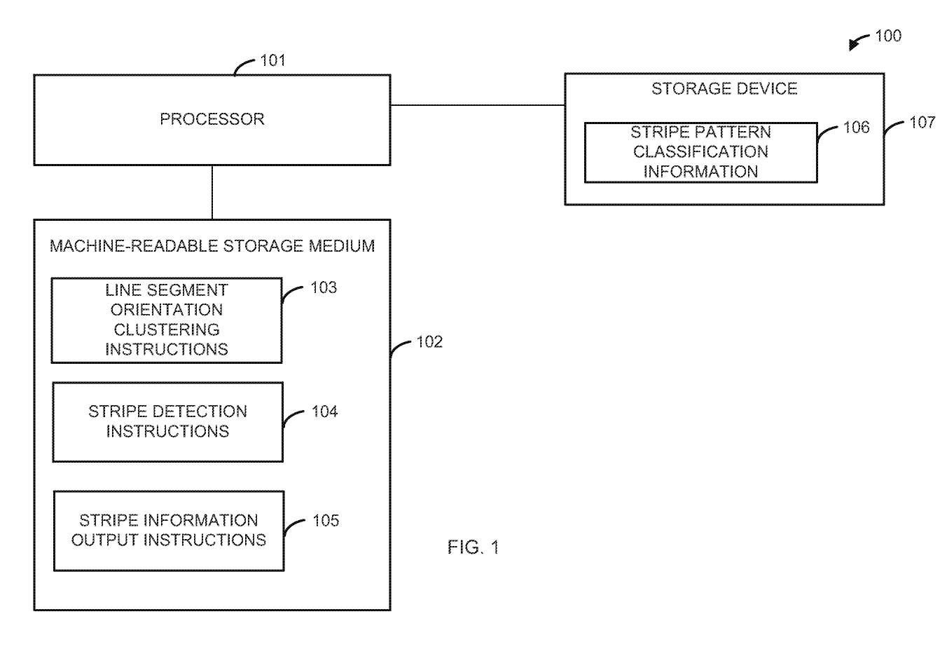

FIG. 1 is a block diagram illustrating one example of a computing system to detect clothing stripes in an image. For example, the computing system 100 may determine whether stripes are present within a clothing region in an image. The computing system 100 may include a processor 101, a machine-readable storage medium 102, and a storage device 107. The computing system 100 components may be included within the same apparatus, or may include components communicating with one another, such as via a network.

The storage device 107 may be any suitable storage device, such as an electronic, magnetic, optical, or other physical storage device. In one implementation, the machine-readable storage medium 102 and the storage device 107 are the same storage device. The storage device 107 may store data accessible to the processor 101. The storage device 107 may store stripe pattern classification information 106. The stripe pattern classification information 106 may be information related to a machine learning method for classifying whether a clothing region in an image includes stripes based on the orientation of line segments within the clothing region.

The stripe pattern classification information 106 may be created based on an analysis of a training data set. The training data set may be analyzed as a supervised learning problem. Methods such as support vector machine or random forest may be used to build a binary classifier to detect the presence or absence of stripes. The training data set may include clothing with and without stripes in different image conditions, such as with different lighting and shadows. The training data set may include images of stripes in different orientations such that the classifier may discover rules related to the orientation of line segment clusters that are indicative of stripes. The stripe pattern classification information 106 may indicate patterns indicative of clothing stripes. For example, shorts may have a pattern of a cluster of line segments of a first orientation for a first leg and a cluster of line segments of a slightly different orientation for a second leg.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium.

The machine-readable storage medium 102 may include line segment orientation clustering instructions 103, stripe detection instructions 104, and stripe information output instructions 105. The line segment orientation clustering instructions 103 may include instructions for determining stripe candidate line segments. For example, line segments of the same orientation may be clustered together, and summary information about the clusters may be created. As an example, a vector where each vector element represents a line segment orientation may be created with the element values indicating the number of line segments in the particular orientation associated with that element. An edge detection method may be used to detect line segments within a clothing region of the image. Further processing may be performed to determine if the detected edges are likely to be stripes. The orientation of the edges may be determined of the line segments likely to be stripes. For example, the line segment orientation may be determined by the position difference between one end of the line segment and the other end of the line segment.

In some cases, information in addition to line segment orientation may be considered to determine whether a cluster of line segments are stripe candidates. For example, the length of the line segments or the distance of the line segments from one another may be considered. In one implementation, color between the line segments may be analyzed to determine if the color pattern is consistent with stripes. For example, the color on each side of two line segments may be analyzed to determine if the color is the same. If the color is different, the line segments may be removed from the list of stripe candidate clusters. A cluster of line segments may also be pruned where the number of line segments in the cluster is below a threshold. For example, two line segments of the same orientation may be too low to be likely to be indicative of stripes.

The stripe detection instructions 104 may include instructions for comparing the clusters of line segments to the stripe pattern classification information 106. For example, a machine learning classifier may be applied to the line segment clusters. In some cases, a particular pattern of line segment orientations may be likely to be indicative of stripes. For example, a first orientation and a second orientation with a relationship to the first orientation may indicate stripes due to the slightly different stripe orientations on the middle of the shirt compared to the sleeves. Based on the analysis of the line segment cluster orientations, the machine classifier may determine whether stripes are present in the clothing region or not.

The stripe information output instructions 105 may include instructions for outputting information about the stripe detection. A binary value may be output from the machine learning classifier indicating the presence or absence of stripes. The information may be output by storing, transmitting, or displaying it. In some cases, a stripe orientation may be input, and images within a group of images with clothing regions including the stripe orientation may be output.

In one implementation, the dominant orientation of the stripes may also be determined and output. For example, the orientations of the line segments may be associated with larger categories, such as horizontal, vertical, and diagonal. The orientation of the line segment clusters with the largest number of line segments may be considered to be the dominant stripe or the line segment orientation taking up the largest amount of space in the clothing region may be considered to be the dominant stripe.

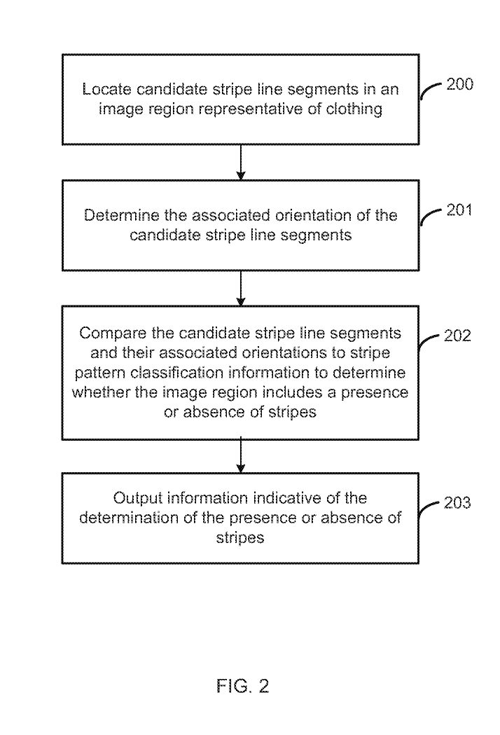

FIG. 2 is a flow chart illustrating one example of a method to detect clothing stripes in an image. For example, the presence or absence of stripes in a clothing region of an image may be determined based on the orientation of clusters of line segments in an image. For example, clusters of line segments in the clothing region may be identified, and clusters determined to be candidate stripe clusters may be classified according to a machine learning classifier that outputs a binary value indicating whether the feature vector of the clusters is likely to be indicative of clothing stripes. The method may be implemented, for example, by the processor 101 of FIG. 1.

Beginning at 200, a processor locates candidate line segments in an image region representative of clothing. For example, the processor may locate line segments within a clothing region of an image that are candidates for clothing stripes.

The region representative of clothing may be a region associated with any type of clothing item, such as shirts, socks, handbags, pants, headbands, or other clothing articles. The processor may receive the image region representative of clothing, such as where the processor receives information about the particular region or receives the image cropped to the clothing region.

In one implementation, the processor receives an image, and the processor determines the region of the image representative of clothing. For example, the processor may perform preprocessing on the image to determine which areas of the image are likely to be associated with clothing. In some cases, the preprocessing may be performed based on a machine learning classifier for identifying clothing regions. The processor may determine whether clothing is likely to be present in an image using a face detection method. For example, if a face is not located in an image, the processor may determine that the image is unlikely to include a clothing region. A detected face region may be used to determine the relative location of the clothing region. False face detection may be reduced by using a skin validation module to use skin color to validate the face detection. The processor may locate a region relative to the face, such as by using a bounding box with a relative position and scale of the detected face. After a clothing region is identified, the processor may further reduce the clothing segment by eliminating non-clothing pixels, such as removing human skin, cluttered background, and self and third-party occlusion from the clothing segments.

An image may include multiple clothing regions, such as where multiple people are in an image. In some cases, a separate clothing region is determined for different articles of clothing, such as a clothing region for a handbag and a clothing region for a shirt.

The processor may determine the candidate stripe line segments in any suitable manner. For example, straight line segments of a particular length or line segment indicating an edge may be candidate line segments. The processor may locate edges within the clothing region as potential stripe line segments. In one implementation, the processor uses a Canny edge detector or other edge detection method. The process then determines which of the detected edges form line segments that meet criteria of candidate stripe line segments. In one implementation, each clothing edge detected in the clothing region is classified as a candidate stripe line segment without determining if the line segments meet other criteria.

Continuing to 201, the processor determines the associated orientation of the candidate line segments. For example, a cluster of line segments of the same orientation may be stripes. The processor may determine an orientation of a line segment by comparing the angle of a line segment to a set range associated with an orientation. As one example, there are 24 orientation ranges covering the 360 degrees of possibilities of orientation ranges. In one implementation, the processor clusters line segments that are within a range of degrees of orientation from one another. The orientation of the line segments may be determined relative to the edge of the image or relative to a person region, For example, the line segment orientation may be determined based on the position of a face relative to the clothing segment.

In one implementation, the processor further analyzes the line segment clusters to determine if a cluster of line segments of a particular orientation is a stripe candidate. The line segment clusters may be discarded where they are not consistent with stripe patterns, For example, a set of line segments of an orientation with a number of line segments below a threshold number may be discarded, such as where there are three or fewer line segments of a particular orientation. The line segments found in small numbers may be indicative of false edges, self shadows, or other image artifacts not indicative of stripes.

In one implementation, the line segment clusters are analyzed for their adjacent color properties. For example, stripes may typically have the same color on either side of the stripe. The processor may analyze the color on the outer side of two line segments next to one another to determine if the color is the same. If the color is different, the line segment cluster may be removed from the candidate list. In one implementation, the number of different colors between the line segments is analyzed, and if there is a number of colors above a threshold, the cluster of line segments is pruned from the candidate list.

In one implementation, the processor creates a stripe signature of the clothing region based on the different stripe orientations in the clothing region. For example, there may be a list of 24 stored orientation ranges, and a first clothing region may include line segment clusters in orientation 2, 4, and 6, and a second clothing region may include line segment clusters in orientation 10.

Moving to 202, the processor compares the line segment clusters and their associated orientations to stripe pattern classification information to determine whether the image region includes a presence or absence of stripes. The stripe pattern classification information may be, for example, a machine learning classifier, such as a random forest classifier. The input to the classifier may be, for example, a stripe signature indicating the distribution of line segment orientation. In one implementation, the stripe signature is a vector or histogram indicating whether a line segment cluster was identified at different orientations. The stripe signature may include binary values indicating whether line segments are identified at the possible orientations, or the stripe signature may indicate the number of line segments identified at each of the possible orientations.

In one implementation, the processor compares the different orientations of line dusters to information about the groups of orientations of line clusters indicative of stripes. For example, clusters of orientation 4, 6, and 10 where each represents a different orientation range may be indicative of stripes, but clusters of orientation 4, 6, 10, 12, and 13 may not be indicative of stripes.

In one implementation, additional information is also used to determine the presence of stripes in addition to orientation information. In one implementation, the processor further compares the number of line segments in each cluster to the stripe pattern classification information, such as where a particular orientation has a number of line segments above a threshold. For example, more than 10 line segments of orientation 4 in addition to more than 5 line segments of orientation 8 may be indicative of stripes. In one implementation the stripe pattern classification information compares both high and low thresholds, such as where a line segment cluster of a particular orientation with between 5 and 10 line segments is indicative of stripes.

Any suitable additional information may be considered, such as the line segment distance from one another or the length of the line segments in the cluster. The distance between the clusters of line segments of different orientations may also be evaluated.

In one implementation, the processor further determines the dominant orientation of the stripes if it is determined that stripes are present in the clothing region. The dominant orientation may be determined in any suitable manner. For example, the processor may output the dominant stripe orientation as the orientation with the largest number of line segments in the cluster. In one implementation, the orientations used for detecting stripes are grouped into larger groups to determine a dominant stripe orientation. For example, the orientations for detecting stripes may be more specific than summary dominant stripe information, The dominant stripe orientation category with the largest number of line segments may be determined to be the dominant stripe orientation. In one implementation, the relative position of a face to the clothing region is used to determine the dominant strip orientation. The largest number of line segments in a particular position relative to the face region may be determined to be the dominant stripe orientation.

Proceeding to 203, the processor outputs information indicative of the determination of the presence or absence of stripes. The output may be a binary output indicating the presence or absence of stripes. In one implementation, the output indicates a likelihood that the clothing region includes stripes, such as an 80% likelihood. The information may be output in any suitable manner, such as by displaying, storing, or transmitting the information. The processor may also output information about the dominant orientation of the stripes. The processor may output additional information about the stripes, such as the dominant color or the estimated stripe width.

The processor may use the stripe determination to provide additional output. For example, a user may provide a photograph collection, and the processor may output the photographs in the collection that are determined to include striped clothing.

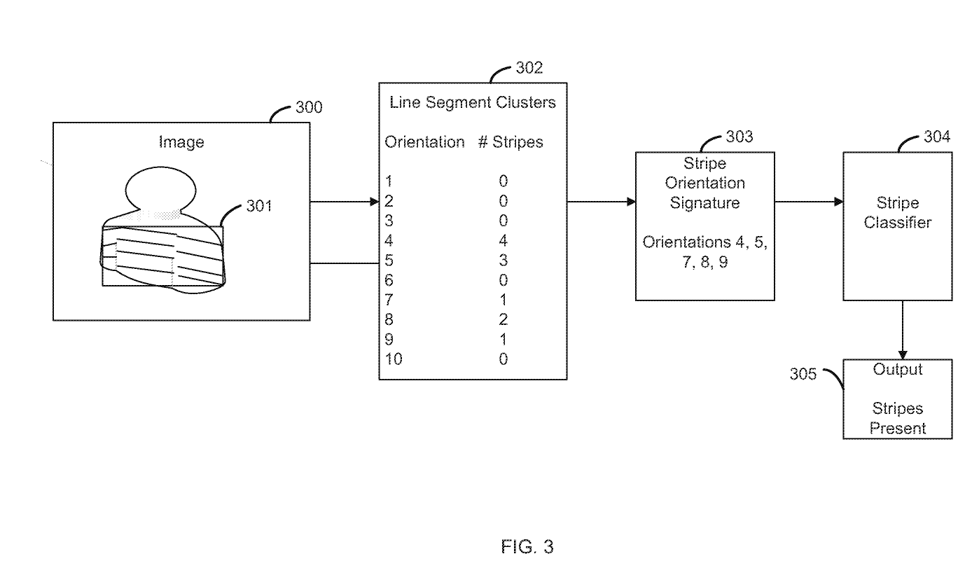

FIG. 3 is a diagram illustrating one example of detecting stripes within an image. FIG. 3 includes an image 300 of a person. Clothing region 301 forms a bounding box on the clothing region of the person in the image. In some cases, there may be multiple clothing bounding boxes within an image, such as where the image includes multiple people. The clothing region 301 includes 11 stripes. The stripes are at different orientations on the front of the shirt compared to the sleeves.

At 302, the line segments are clustered according to orientation, and the orientation of the clusters are determined. For example, a classifier may classify the edges in the clothing region 301 to the 10 stripe orientation bins. For example, there are no stripes of orientation 1 and 2, but 4 stripes of orientation 4. The line clusters and orientations may be represented in any suitable manner, such as in a vector data structure or in a database table.

At 303, the orientations of the line segment clusters are extracted and serve as input to the stripe classifier at 304. At 304, the stripe classifier compares the orientations from 303 to orientation rules indicative of stripes learned from a machine learning method applied to training data sets. At 305, the stripe classifier determines that stripes are present, and the information is output.

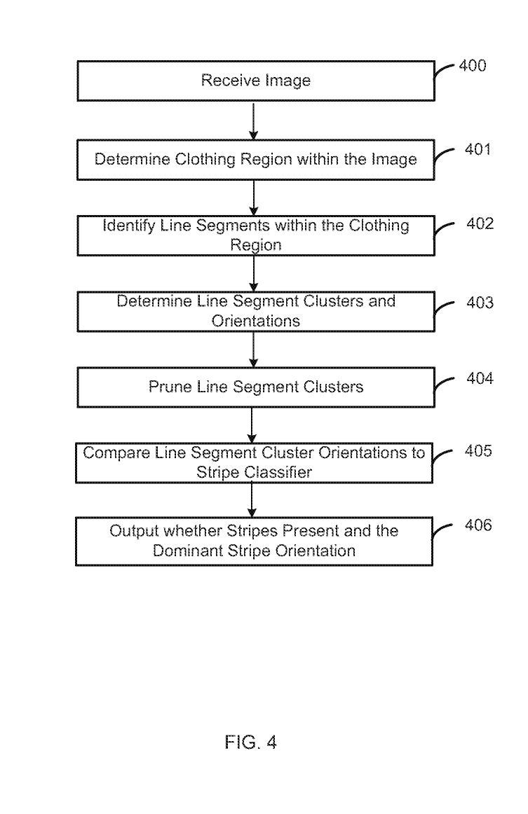

FIG. 4 is a flow chart illustrating one example of detecting clothing stripes within an image. The method may be implemented, for example, by the processor 101 of FIG. 1. Beginning at 400, a processor receives an Image. The processor may retrieve the image, or the image may be provided by user input.

At 401, the processor determines a clothing region within the received image. Image analysis may be performed to locate a face region in the image and locate a clothing region in a relative region to the face region. Image areas not indicative of clothing may be removed from the clothing region, such as background areas. At 402, the processor identifies line segments within the clothing segment. For example, a Canny edge detector method may be used to identify line segments. At 403, the processor determines line segment clusters and orientations of line segments. The line segments may be grouped by orientation by classifying the line segments, or each individual line segment may be analyzed and added to an orientation group. At 404, the processor prunes the line segment clusters. For example, the identified line segments may be clustered by orientation, and the clusters may be filtered to remove clusters unlikely to be indicative of clothing stripes. At 405, the processor compares line segment cluster orientations to a stripe classifier. The stripe classifier may be a classifier created from a machine learning method that associates particular line segment orientations with a likelihood of clothing stripes. At 407, the processor outputs whether stripes are present and the dominant stripe orientation.

Clothing stripes may be accurately and efficiently detected based on analysis of line segment orientation within a clothing region of an image. Determining whether clothing includes stripes is useful for image searching, classification, and management.

1. A computing system, comprising:
a storage device to store stripe pattern classification information derived from a stripe pattern training data set;
a processor to:
cluster line segments in a clothing region of an image based on line segment orientation;
determining whether stripes are included within the clothing region based on a classifier applied to the line segment dusters; and
output information indicating the determination of whether the clothing region includes stripes.

2. The computing system of claim 1, wherein the processor is further to:
determine a dominant orientation of the stripes if determined stripes are present; and
output information indicating the dominant orientation of the stripes.

3. The computing system of claim 1, wherein the processor is further to locate the clothing region within the image based on at least one of: facial analysis and background image analysis.

4. The computing system of claim 1, wherein the processor is further to:
prune the line segment cluster based on image color adjacent to the line segments in the cluster; and
determine whether stripes are included within the clothing region based on the classifier applied to the remaining line segment clusters.

5. The computing system of claim 1, wherein the processor is further to:
prune a line segment cluster if the number of line segments within the cluster is below a threshold; and
determine whether stripes are included within the clothing region based on the classifier applied to the remaining line segment clusters.

6. The computing system of claim 1, wherein the stripe pattern classification information comprises information about line segment patterns indicative of stripes based on at least one of: the number, distance, length, and orientation of the line segments.

7. A method, comprising:
locating candidate stripe line segments in an image region representative of clothing;
determining the associated orientation of the candidate stripe line segments;
comparing, by a processor, the candidate stripe line segments and their associated orientations to stripe pattern classification information to determine whether the image region includes a presence or absence of stripes; and
outputting information indicative of the determination of the presence or absence of stripes.

8. The method of claim 7, further comprising determining the dominant orientation of the stripes if determined stripes are present.

9. The method of claim 7, wherein determining candidate stripe line segments comprises determining candidate stripe line segments based on the color adjacent to the candidate stripe line segments.

10. The method of claim 7, further comprising pruning candidate line segments where the number of candidate stripe line segments with the same orientation is below a threshold.

11. The method of claim 7, further comprising determining the region of the image representative of clothing.

12. A machine-readable non-transitory storage medium comprising instructions executable by a processor to:
determine whether a clothing region within an image includes stripes based on a stripe classifier applied to candidate line segment information related to the clothing segment,
wherein the candidate line segment information includes the number of candidate line segments in the clothing region at each of a plurality of orientations; and
output information indicating the determination of whether the clothing region includes stripes.

13. The machine-readable non-transitory storage medium of claim 12, further comprising instructions to determine a dominant orientation of stripes within the clothing segment if determined the clothing region includes stripes.

14. The machine-readable non-transitory storage medium of claim 12, further comprising instructions to select the candidate line segments based on at least one of: line segment orientation, line segment number, and color between the line segments.

15. The machine-readable non-transitory storage medium of claim 12, further comprising instructions to create the stripe classifier based on a training data set.
